(19) United States
(12) Patent Application Publication
(10) Pub. No.: US 2013/0114246 A1
(43) Pub. Date: May 9, 2013

(54) LIGHT SOURCE APPARATUS, BACKLIGHT UNIT HAVING THE SAME AND METHOD OF MANUFACTURING LIGHT SOURCE APPARATUS

(71) Applicant: SAMSUNG ELECTRONICS CO., LTD., Suwon-si (KR)

(72) Inventors: Jung Kyu PARK, Seoul (KR); Dae Woon HONG, Osan (KR); Sung A. CHOI, Suwon (KR); Young Guen JUN, Seongnam (KR); Jung Kyu KOOK, Seoul (KR); Worl Sung SHIN, Incheon (KR)

(73) Assignee: SAMSUNG ELECTRONICS CO., LTD., Suwon-si (KR)

(21) Appl. No.: 13/671,031

(22) Filed: Nov. 7, 2012

(30) Foreign Application Priority Data
Nov. 7, 2011 (KR) 10-2011-0114930

(51) Int. Cl. F21V 5/04; G09F 13/04

(52) U.S. Cl. CPC F21V 5/04; G09F 13/04
USPC 362/97.1; 362/311.01; 362/311.1; 156/292

(57) ABSTRACT

A light source apparatus, and a backlight unit including the same, and a method of manufacturing the light source apparatus are provided. The light source apparatus includes: a base substrate; a light source disposed on the base substrate; a lens disposed above the light source and including a hollow part in which the light source is housed and having a shape corresponding to an outer peripheral surface of the light source; and an adhesive fixing the lens to the base substrate in a state in which the outer peripheral surface of the light source contacts at least a part of an inner surface of the hollow part.

### CROSS-REFERENCE TO RELATED APPLICATION

This application claims priority from Korean Patent Application No. 10-2011-0114930, filed on Nov. 7, 2011 in the Korean Intellectual Property Office, the disclosure of which is incorporated herein by reference in its entirety.

### BACKGROUND

1. Field

Apparatuses and methods consistent with exemplary embodiments relate to a light source apparatus, and a backlight unit having the same, and a method of manufacturing the light source apparatus.

2. Description of the Related Art

Generally, a light emitting device emits light by converting electrical energy into light including ultraviolet rays, infrared rays, and visible light rays by using the characteristics of a compound semiconductor. A light emitting diode (LED) is a type of electroluminescent (EL) device. At present, LEDs using group III-V compound semiconductors have been commercialized. A group III-nitride compound semiconductor is a direct transition semiconductor able to operate stably at a temperature higher than that possible in other semiconductors. Therefore, III-nitride compound semiconductors have been widely used in light emitting devices, such as light emitting diodes (LEDs), laser diodes (LDs), and the like.

When a light emitting device is used in a light source apparatus, various attempts to focus or diffuse light emitted therefrom, according to usage, have been made. For example, in order to induce light to move in a desired direction, a separate reflecting member may be used, or in order to diffuse light in a predetermined direction, a diffusing member may be used. In addition, in order to change light distribution characteristics and a light orientation angle, variously shaped lenses may be disposed on a light emitting surface. In this case, assembly tolerance between the light emitting device and the lens in a vertical or horizontal direction may affect the characteristics of emitted light.

### SUMMARY

One or more exemplary embodiments provide a light source apparatus having improved light emission characteristics.

One or more exemplary embodiments also provide a method of manufacturing a light source apparatus capable of improving manufacturing efficiency while simplifying a manufacturing and saving manufacturing costs.

One or more exemplary embodiments also provide a backlight unit having improved light emission uniformity and precision.

According to an aspect of an exemplary embodiment, there is provided a light source apparatus including: a base substrate; a light source disposed on the base substrate; a lens disposed over the light source and including a hollow part having a shape corresponding to an outer peripheral surface of the light source so as to house the light source; and an adhesive fixing the lens to the base substrate in a state in which the outer peripheral surface of the light source contacts at least a part of an inner surface of the hollow part.

A center of the light source may coincide with a center of the lens in the state in which the outer peripheral surface of the light source contacts the at least a part of the inner surface of the hollow part.

The outer peripheral surface of the light source and the at least a part of the inner surface of the hollow part may include a curved surface.

The hollow part may include a first area having a shape corresponding to the outer peripheral surface of the light source, and a second area having a concave semispherical shape to house the light source.

The outer peripheral surface of the light source may contact at least a part of the first area.

The lens may include a protruded part formed in an inner peripheral surface of the first area.

The outer peripheral surface of the light source may contact the protruded part.

The lens may include a convex part protruded upwardly, and the convex part may have a concave part formed therein.

A center of the convex part may coincide with a center of the concave part.

The light source may be disposed on the center of the convex part and the concave part.

The adhesive may include a thermosetting material.

The adhesive may be cured to fix the lens to the base substrate, and the adhesive may have fluidity before being cured.

The lens may be fixed to the base substrate without being in contact therewith.

The light source may include: a pair of lead frames; a light emitting device disposed on the pair of lead frames; and a molding part sealing the light emitting device.

According to an aspect of another exemplary embodiment, there is provided a method of manufacturing a light source apparatus, the method including: disposing a light source on a base substrate; applying an adhesive having fluidity to an area surrounding the light source of the base substrate; disposing a lens including a hollow part housing the light source on the adhesive having fluidity; and fixing the lens to the base substrate by the adhesive in a state in which an outer peripheral surface of the light source contacts at least a part of an inner surface of the hollow part.

In the disposing of the lens on the adhesive, the lens may be automatically aligned so that the outer peripheral surface of the light source contacts the at least a part of the inner surface of the hollow part.

A center of the light source may coincide with a center of the lens in the state in which the outer peripheral surface of the light source contacts the at least a part of the inner surface of the hollow part.

The hollow part may include a first area having a shape corresponding to the outer peripheral surface of the light source, and a second area having a concave semispherical shape to house the light source.

The outer peripheral surface of the light source may be fixed in a state in which the outer peripheral surface of the light source contacts at least a part of the first area.

The lens may be fixed to the base substrate without being in contact therewith.

According to an aspect of another exemplary embodiment, there is provided a backlight unit, including: a base substrate; a light source part including a light source disposed on the base substrate; a lens disposed above the light source and including a hollow part having a shape corresponding to an outer peripheral surface of the light source so as to house the light source; and an adhesive fixing the lens to the base substrate in a state in which the outer peripheral surface of the light source contacts at least a part of an inner surface of the hollow part; and a diffusing plate separately disposed above the light source part.

A center of the light source may coincide with a center of the lens in the state in which the outer peripheral surface of the light source contacts the at least a part of the inner surface of the hollow part.

The adhesive may include a thermosetting material.

The outer peripheral surface of the light source and the at least a part of the inner surface of the hollow part may include a curved surface.

The light source may include: a pair of lead frames; a light emitting device disposed on the pair of lead frames; and a molding part sealing the light emitting device.

### BRIEF DESCRIPTION OF THE DRAWINGS

The above and/or other aspects will be more clearly understood from the following detailed description taken in conjunction with the accompanying drawings, in which:

FIG. 1 is a cross-sectional view schematically showing a light source apparatus according to an exemplary embodiment;

FIGS. 2A and 2B are perspective views schematically showing a light source and a lens configuring the light source apparatus shown in FIG. 1;

FIGS. 3A to 3D are views describing a method of manufacturing a light source apparatus according to another exemplary embodiment;

FIGS. 4A and 4B are perspective views schematically showing a modified example of a light source and a lens applicable to a light source apparatus and a method of manufacturing a light source apparatus according to another exemplary embodiment; and

FIG. 5 is a cross-sectional view schematically showing a backlight unit according to another exemplary embodiment.

### DETAILED DESCRIPTION OF EXEMPLARY EMBODIMENTS

Exemplary embodiments will now be described in detail with reference to the accompanying drawings.

Exemplary embodiments may be modified in many different forms and the scope of exemplary embodiments should not be seen as being limited to the exemplary embodiments set forth herein. Rather, these exemplary embodiments are provided so that this disclosure will be thorough and complete, and will fully convey the concept of exemplary embodiments to those skilled in the art. Therefore, in the drawings, the shapes and dimensions of components may be exaggerated for clarity, and the same reference numerals will be used throughout to designate the same or like components.

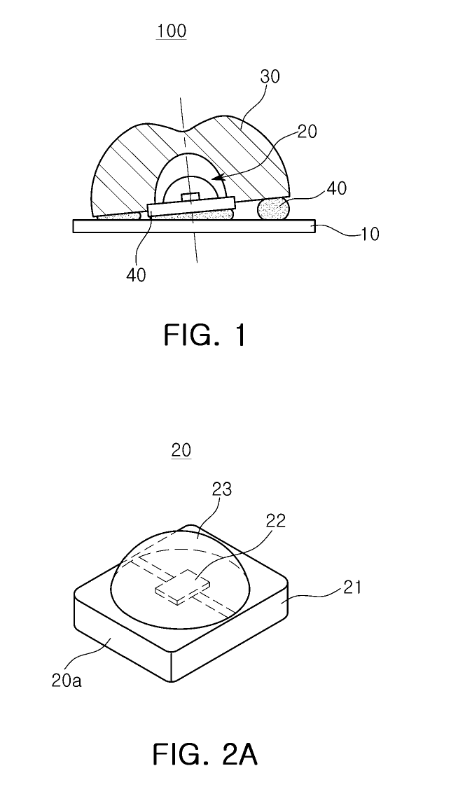

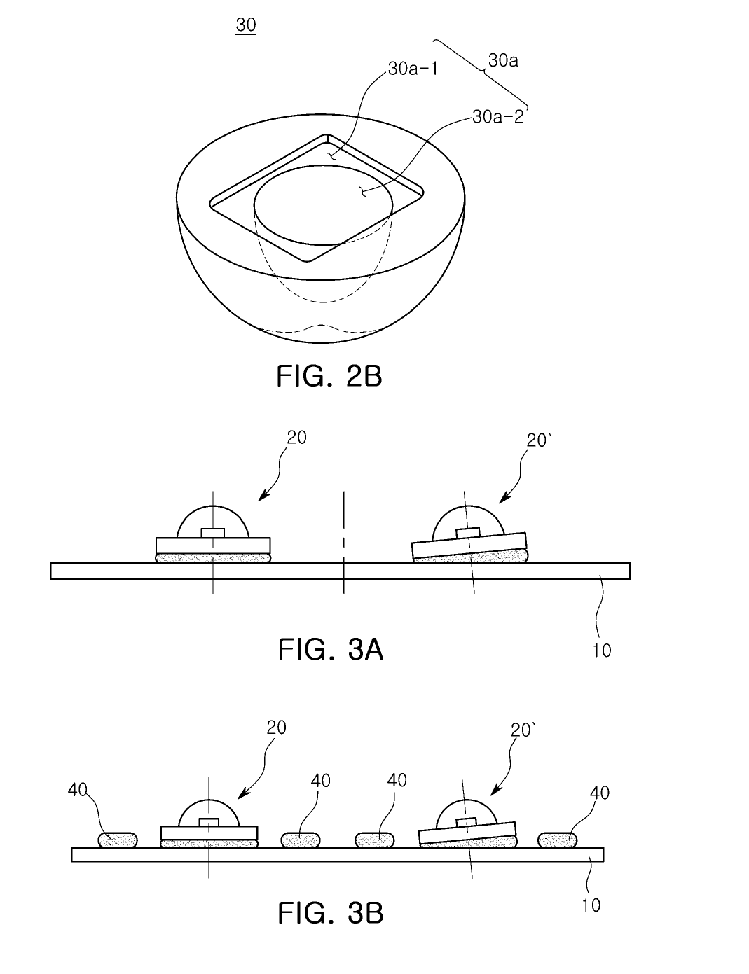

FIG. 1 is a cross-sectional view schematically showing a light source apparatus 100 according to an exemplary embodiment and FIGS. 2A and 2B are perspective views schematically showing a light source 20 and a lens 30 configuring the light source apparatus 100 shown in FIG. 1.

Referring to FIGS. 1, 2A, and 2B, a light source apparatus 100 according to an exemplary embodiment may include a base substrate 10, a light source 20 disposed on the base substrate 10, a lens 30 disposed above/over the light source 20, and an adhesive 40 fixing the lens 30 to the base substrate 10.

The lens 30 may include a hollow part 30a corresponding to a shape of an outer peripheral surface 20a of the light source 20 so as to house the light source 20. The adhesive 40 may be fixed in a state in which the outer peripheral surface 20a of the light source 20 contacts at least a part of an inner surface of the hollow part 30a.

The base substrate 10 may be a printed circuit board (PCB) substrate that is electrically connected to the light source 20. The PCB substrate may be formed of (i.e., include) organic resin materials containing epoxy, triazine, silicon, polyimide, or the like, other organic resin materials, ceramic materials such as AlN, Al2O3, or the like, or metals and metal compound materials. In detail, the PCB substrate may be a metal-core printed circuit board (MCPCB), which is a type of a metal PCB.

However, it is understood that the base substrate 10 is not limited to a printed circuit board (PCB) in one or more other exemplary embodiments, and both a surface on which the light source 20 is disposed and a surface opposite thereto may be provided with wirings electrically connected to the light source 20. In this case, the wirings disposed on the surface on which the light source 20 of the base substrate 10 is mounted may be connected to wirings formed or disposed on the opposite surface via through holes or bumps.

The light source 20 may include a pair of lead frames 21, a light emitting device 22 disposed on the lead frames, and a molding part 23 sealing the light emitting device.

The pair of lead frames 21 may be electrically connected to the light emitting device 22 by using conductive wires or by being in contact with the light emitting device 22, and may be used as terminals for applying external electrical signals. To this end, the lead frame 21 may be formed of highly conductive metal materials.

Any light emitting device may be used so long as it is a photoelectric device that can emit light when electricity is applied thereto. An example of a representative light emitting device may include a light emitting diode (LED) chip. As an example, the light emitting device 22 may be a gallium nitride (GaN) LED chip that emits blue light. As described below, at least a portion of blue light may be converted into light of other colors due to wavelength conversion materials included in the molding part 23.

According to an exemplary embodiment, the molding part 23 may be provided in a path of light emitted from the light emitting device 22 while sealing the light emitting device 22. In detail, the molding part 23 may be formed of a silicon-based transparent resin and an epoxy-based transparent resin and protects the light emitting device 22. Furthermore, the molding part 23 may match a refractive index of a material forming the light emitting device 22 with that of the outside to improve external light extraction efficiency.

The molding part 23 may include phosphor particles for wavelength conversion that convert wavelengths of light emitted from the light emitting device 22. The phosphor may include a phosphor that converts a wavelength of light into any one of yellow, red, and green light wavelengths and a type of phosphor may be determined based on a wavelength of light emitted from the light emitting device 22. In detail, the molding part 23 may include any one of YAG-based, TAG-based, silicate-based, sulfide-based, nitride-based, etc., fluorescent materials. For example, when a phosphor converting a wavelength of light into yellow light is applied to the blue light emitting LED chip, a white light emitting semiconductor device can be obtained.

The lens 30 including the hollow part 30a in which the light source 20 is housed may be disposed above the light source 20. As long as materials of the lens 30 are capable of transmitting light, components thereof are not particularly limited. Accordingly, an insulating resin having transparency, such as a silicon resin composition, a modified silicon resin composition, an epoxy resin composition, a modified epoxy resin composition, an acrylic resin composition, or the like, may be used. In addition, a resin having excellent weather resistance, such as a hybrid resin, or the like, including at least one of silicon, epoxy, and boron resins, may be used. The materials of the lens 30 are not limited to organic materials, and inorganic materials having excellent light resistance, such as glass, silica gel, or the like, may also be used. In addition, the lens 30 is formed as a convex lens, a concave lens, an oval lens, or the like, by adjusting a surface shape of the lens 30, thereby controlling light distribution.

According to an exemplary embodiment, the lens 30 may include a convex part that protrudes upwardly and a concave part included in the convex part. The orientation angle of light emitted from the light source 20 may be wide and light distribution characteristics may be changed by including the concave part in the lens 30. In detail, the concave part may be formed in a central area of the convex part so as to have a smaller diameter than a maximum diameter of the convex part and a center of the concave part may coincide with a center of the convex part. In this case, the light source 20 may be disposed on a center line of the convex part and the concave part.

The lens 30 may include the hollow part 30a having a shape corresponding to the outer peripheral surface 20a of the light source 20. The hollow part 30a has a shape corresponding to the outer peripheral surface 20a of the light source 20 such that the hollow part 30a may have at least a part of the light source 20 housed therein.

In detail, the hollow part 30a may include a first area 30a-1 having a shape corresponding to the outer peripheral surface 20a of the light source 20 and a second area 30a-2 having a semispherical shape depressed to house the light source 20. The outer peripheral surface 20a of the light source 20 contacts at least a part of the first area 30a-1 in the hollow part 30a so that a central axis of the light source 20 and a central axis of the lens 30 may be automatically aligned to coincide with each other.

In this case, the outer peripheral surface 20a of the light source and at least a part of an inner surface of the hollow part 30a include a curved surface so that the lens 30 may be easily automatically aligned above the light source 20.

The adhesive 40 may fix the lens 30 to the base substrate 10 in the state in which the outer peripheral surface 20a of the light source 20 contacts at least a part of the inner surface of the hollow part 30a of the lens 30.

The adhesive 40 may include thermosetting materials. That is, the adhesive 40, when heated, is softened to have fluidity. Therefore, the adhesive may include materials that can be easily deformed when heated, but that may not be softened even in the case that the materials are reheated once the adhesive has cooled, and thus, cannot be deformed to have further shapes.

For example, a thermosetting resin such as a phenol resin, a urea resin, a melanin resin, an unsaturated polyester, an epoxy resin, a polyurethane resin, or the like may be used, though it is understood that exemplary embodiments are not limited thereto.

According to an exemplary embodiment, the adhesive 40 may serve to fix the lens 30 when automatically aligned, so that the central axis of the lens 30 coincides with the central axis of the light source 20 disposed on the base substrate 10. In detail, the lens 30 may be disposed above the light source 20 in the state in which the adhesive 40 has fluidity before being cured, and the lens 30 may be aligned on the adhesive 40 having fluidity so as to contact the hollow part 30a having a shape corresponding to the outer peripheral surface 20a of the light source 20.

In this case, the center of the light source 20 coincides with the center of the lens 30 because of contact between the outer peripheral surface 20a of the light source 20 and at least a part of the inner surface of the hollow part 30a. In this state, the adhesive 40 is cured and thus, the lens 30 may be fixed to the base substrate 10.

That is, according to an exemplary embodiment, the lens 30 is automatically aligned and fixed according to an arrangement of the light source 20, and thus, the central axes of the light source 20 and the lens 30 coincide with each other, thereby precisely controlling light distribution and improving light distribution characteristics.

In addition, as shown in FIG. 1, the lens 30 may be fixed in a state in which the lens 30 does not contact the base substrate 10. In this case, the alignment structure is formed only by the light source 20 and the lens 30, thereby minimizing external interference that may be caused by assembly equipment or processes.

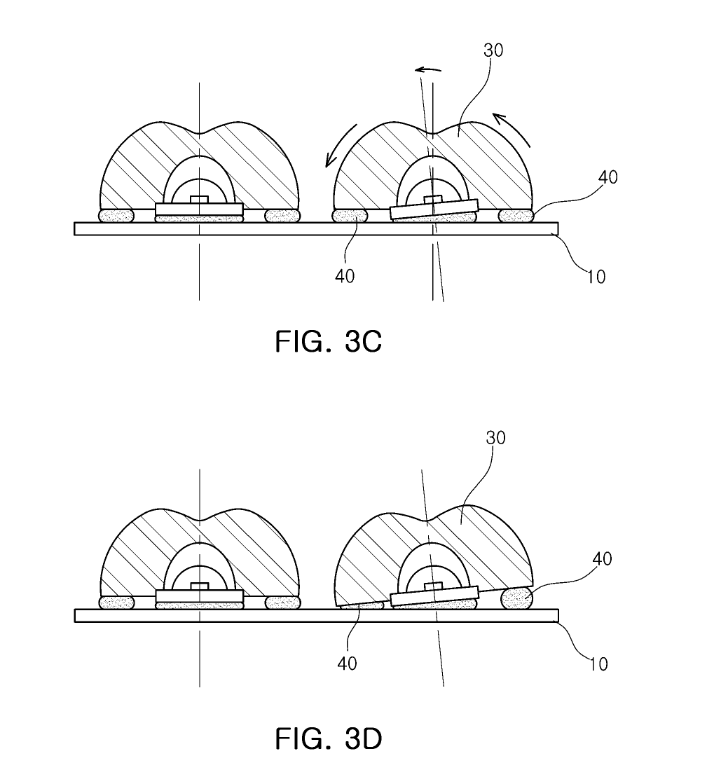

FIGS. 3A to 3D are views describing a method of manufacturing a light source apparatus according to another exemplary embodiment. Here, a method of manufacturing the light source apparatus shown in FIG. 1 will be described in detail.

The method of manufacturing the light source apparatus according to the present exemplary embodiment may include disposing the light source 20 on the base substrate 10, applying the adhesive 40 to the base substrate 10, disposing the lens 30 on the adhesive 40, and fixing the lens 30 to the base substrate 10.

The adhesive 40 may be applied to an area surrounding the light source 20 in the state in which the adhesive 40 has fluidity, and the lens 30 may include the hollow part 30a housing the light source 20. The lens 30 may be fixed to the base substrate 10 by the adhesive 40 in the state in which the outer peripheral surface 20a of the light source contacts at least a part of the inner surface of the hollow part 30a.

First, referring to FIG. 3A, the light source 20 may be disposed on the base substrate 10.

As described above, the base substrate 10 may be a PCB substrate that is electrically connected to the light source 20. The PCB substrate may be formed of organic resin materials containing epoxy, triazine, silicon, polyimide, or the like, other organic resin materials, ceramic materials such as AlN, Al2O3, or the like, or metals and metal compound materials. In detail, the PCB substrate may be a metal-core printed circuit board (MCPCB), which is a type of a metal PCB.

The light source 20 disposed on the base substrate 10 may be configured as a light emitting device package that includes the pair of lead frames 21, the light emitting device 22 disposed on the lead frames 21, and the molding part 23 sealing the light emitting device 22.

The pair of lead frames 21 of the light source 20 may be disposed to contact wire patterns formed on the base substrate 10. At this time, a bonding process such as soldering, or the like, may be used. In this case, an optical axis of the light source 20 is disposed to coincide with a normal line of the base substrate 10. However, as shown in FIG. 3A, an optical axis of a light source 20′ may be deviated from a normal direction of the base substrate 10 by a predetermined angle due to a process error.

In order to compare a case in which the normal line and the optical axis of the light source 20 are disposed so as to coincide with each other and a case in which the normal line and the optical axis of the light source 20′ are disposed so as not to coincide with each other, FIGS. 3A through 3D show that two light sources 20 and 20′ are disposed on the base substrate 10, though it is understood that only one light source 20 or more than two light sources 20 may be disposed on the base substrate 10 in other exemplary embodiments.

Next, as shown in FIG. 3B, the adhesive 40 having fluidity may be applied to an area surrounding the light source 20 of the base substrate 10.

The adhesive 40 is provided to fix the lens disposed above the light source 20 to the base substrate 10, and may include materials having fluidity, for example, thermosetting materials. In this case, the adhesive 40 may have materials that are softened when heated and may easily be deformed, and once cooled, are not softened, even when reheated, and thus, cannot be deformed to have other shapes.

For example, thermosetting resins such as a phenol resin, a urea resin, a melanin resin, an unsaturated polyester, an epoxy resin, a polyurethane resin, and the like may be used, though it is understood that other exemplary embodiments are not limited thereto.

Next, as shown in FIG. 3C, the lens 30 may be disposed on the base substrate 10.

The lens 30 includes the hollow part 30a housing the light source 20 and may be disposed on the adhesive 40 having fluidity. As long as the materials of the lens 30 are capable of transmitting light, the components thereof are not particularly limited. The lens 30 shown in FIG. 3C may be understood as having a form similar to the lens 30 shown in FIG. 2B, although not limited thereto. In addition, the lens 30 may have various shapes and control light distribution by having shapes such as a convex lens, a concave lens, an oval lens, and the like.

According to an exemplary embodiment, the lens 30 may include a convex part that is formed to be protruded upwardly and a concave part formed in the convex part. The orientation angle of light emitted from the light source 20 may be wide and light distribution characteristics may be changed, by forming the concave part in the lens 30. In detail, the concave part may be formed in a central area of the convex part so as to have a smaller diameter than a maximum diameter of the convex part and a center of the concave part may coincide with a center of the convex part. In this case, the light source 20 is disposed on the center line of the convex part and the concave part of the lens 30, and thus, a light source apparatus 100 having an extended light orientation angle may be provided.

However, when the center of the light source 20 does not coincide with the center of the lens 30, light characteristics vary, and thus, an effect of extending the light orientation angle may not be obtained and the effect thereof is insignificant. In detail, when a relative position between the light source 20 and the lens 30 varies in a horizontal direction (i.e., horizontal tolerance), a distance of a center to a peak between the optical axis and peak intensity varies, while when a relative position between the light source 20 and the lens 30 varies in a vertical direct (vertical tolerance), a peak to peak distance between peak intensities varies.

Therefore, the light characteristic uniformity of the light source apparatus including the light source 20 and the lens 30 may be degraded due to the horizontal and vertical tolerances between the light source 20 and the lens 30. In particular, when a plurality of light sources 20 are mounted on a single base substrate 10, the intensities between the light sources 20 become unbalanced and thus, the light distribution may be non-uniform.

According to an exemplary embodiment, the lens 30 includes the hollow part 30a having a shape corresponding to the outer peripheral surface 20a of the light source 20 and is automatically aligned on the adhesive 40 having fluidity so that the center of the lens 30 coincides with the center of the light sources 20 and 20′, thereby solving the problems due to the above-mentioned vertical and horizontal tolerances.

In detail, the hollow part 30a of the lens 30 may include the first area 30a-1 having a shape corresponding to the outer peripheral surface 20a of the light source 20 and the second area 30a-2 having a concave semispherical shape to house the light source 20. The outer peripheral surface 20a of the light source 20 contacts at least a part of the first area 30a-1 in the hollow part 30a so that the central axis of the light source 20 and the central axis of the lens 30 may be automatically aligned to coincide with each other. In this case, the outer peripheral surface of the light source 20 and at least a part of the inner surface of the hollow part 30a may include a curved surface and as a result, the lens 30 may be easily automatically aligned above the light source 20.

Referring to FIG. 3C, the lens 30 disposed above the light sources 20 and 20′ is disposed on the adhesive 40 applied to the base substrate 10. When the light source 20 is disposed so that the center of the light source 20 coincides with the normal line of the base substrate 10 (as with the light source 20 shown at the left of FIG. 3C), the centers of the lens 30 and the light source 20 may coincide with each other. However, when the center of the light source 20′ does not coincide with the normal line of the base substrate 10 (as with the light source 20′ shown at the right of FIG. 3C), the lens 30 is disposed on the adhesive 40 in the state in which the central axis of the lens 30 does not coincide with the central axis of the light source 20′.

According to an exemplary embodiment, the adhesive 40 has fluidity and the lens 30 is disposed thereabove in the state in which the adhesive 40 has fluidity and the hollow part of the lens 30 is formed to have a shape corresponding to the outer peripheral surface of the light source 20′, such that the inner surface of the hollow part may be automatically aligned so as to contact at least a part of the outer peripheral surface of the light source 20′. That is, as shown at the right of FIG. 3C, the lens 30 may be aligned by moving the lens 30 in a direction of the illustrated arrow so that the center of the light source 20′ coincides with the center of the lens 30.

FIG. 3D schematically shows the state in which the lenses 30 disposed above the light sources 20 and 20′ are automatically aligned. The adhesive 40 may fix the lenses 30 to the base substrate 10 in the state in which the lenses 30 are automatically aligned, that is, the state in which the outer peripheral surfaces 20a of the light sources 20 and 20′ contact at least a part of the inner surface of the hollow parts 30a of the lenses 30.

As shown in FIG. 3D, the lenses 30 are fixedly disposed above the light sources 20 and 20′ in the state in which the centers of the light sources 20 and 20′ coincide with the centers of the lenses 30, and as a result, good light distribution characteristics can be obtained.

In addition, the lens 30 may be fixed by the adhesive 40 in the state in which the lens 30 does not contact the base substrate 10. To this end, the first area 30a-1 of the hollow part 30a having a shape corresponding to the outer peripheral surface 20a of the light source 20 may be formed to have a depth smaller than a height of the area forming the outer peripheral surface of the light source 20.

In this case, the alignment structure is formed only by the shapes of the outer peripheral surface 20a of the light source 20 and the hollow part 30a of the lens 30 and therefore, external interference by assembly equipment or processes may be minimized. When such an alignment structure is used in the manufacturing of the light source apparatus 100, the assembly process may be simplified, and manufacturing costs may be saved. Further, the manufacturing speed is fast and thus, the manufacturing efficiency can be improved.

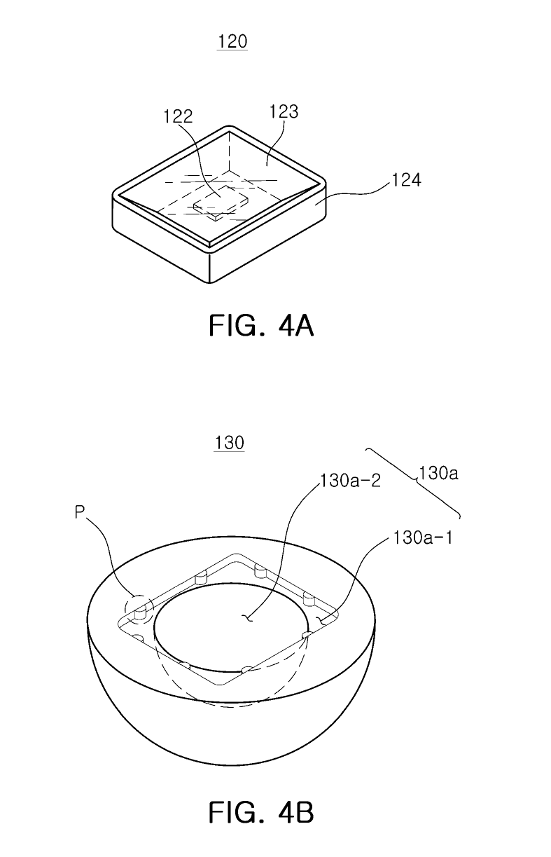

FIGS. 4A and 4B are perspective views schematically showing a modified example of the light source 120 and the lens 130 applicable to the light source apparatus and the method of manufacturing the light source apparatus according to another exemplary embodiment.

The light source apparatus may be configured by coupling a light source 120 shown in FIG. 4A and a lens 130 shown in FIG. 4B with each other, though it is understood that another exemplary embodiment is not limited thereto. Therefore, the light source 120 and the lens 130 may be independently applied to one or more exemplary embodiments.

Referring to FIG. 4A, the light source 120 may include a package body 124 having a concave part, a light emitting device 122 mounted in the concave part of the package body 124, and a molding part 123 filled with a transparent resin so as to seal the light emitting device 122 within the concave part.

Any light emitting device 122 may be used so long as the light emitting device 122 is a photoelectric device that can emit light when electricity is applied thereto. An example of a representative light emitting device 122 may include an LED chip. As an example, the light emitting device 122 may be a gallium nitride (GaN) LED chip that emits blue light. At least a portion of blue light may be converted into light of other colors due to wavelength conversion materials included in the transparent resin.

However, such a structure of the light source 120 applicable to exemplary embodiments is merely an example, and the shape of the light source 120 is not particularly limited. Various types of light sources 120 may be employed so long as the light source 120 includes a light emitting device 122.

Referring to FIG. 4B, the lens 130 may include the hollow part 130a that houses the light sources 20 and 120 and has a shape corresponding to the outer peripheral surfaces 20a of the light sources 20 and 120. The hollow part 130a may include a first area 130a-1 having a shape corresponding to the outer peripheral surfaces 20a of the light sources 20 and 120 and a second area 130a-2 having a shape similar to a semispherical shape to house the light sources 20 and 120.

An inner peripheral surface of the first area 130a-1 may be provided with a protruded part P and the outer peripheral surfaces 20a of the light sources 20 and 120 may be automatically aligned to contact the protruded part P formed in the first area 130a-1. In this case, the lens may be larger than the outer peripheral surfaces 20a of the light sources 20 and 120 so that the hollow part 130a houses at least a part of the light sources 20 and 120.

Unlike the exemplary embodiment shown in FIG. 2, the lens 130 includes a convex part protruded upwardly, wherein the convex part may not have a separate concave part formed therein. In addition to this, the shape of the lens 130 may be variously deformed as needed in consideration of the light distribution characteristics, and the like. In the present exemplary embodiment, the protruded part P is formed in the first area 130a-1 of the hollow part 130a formed in the lens 130 having the convex shape, though it is understood that the surface shape and the protruded part P of the lens 130 are not limited thereto in one or more other exemplary embodiments. For example, as is apparent to those skilled in the art, the shape and the protruded part P of the lens 130 may be separately applied to other exemplary embodiments.

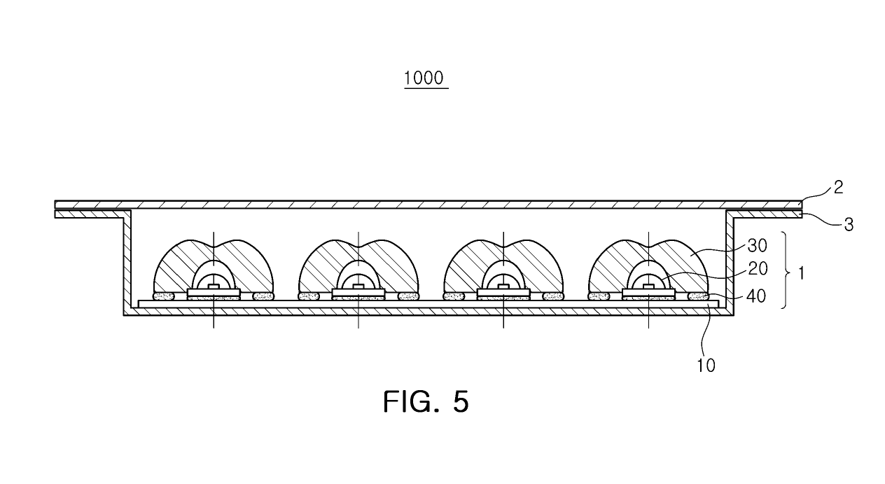

FIG. 5 is a cross-sectional view schematically showing a backlight unit 1000 according to another exemplary embodiment. In detail, a backlight unit 1000 including the light source apparatus shown in FIG. 1 will be described below.

Referring to FIG. 5, a backlight unit 1000 according to the present exemplary embodiment may include the base substrate 10, a light source part 1, and a diffusing plate 2 separately disposed above the light source part 1. The light source part 1 includes the light source 20 disposed on the base substrate 10, the lens 30 disposed above the light source 20, and the adhesive 40 fixing the lens 30 to the base substrate 10.

According to an exemplary embodiment, the light source part 1 including the base substrate 10, the light source 20, the lens 30, and the adhesive 40 may have a similar structure to that of the light source apparatus 100 shown in FIGS. 1, 2A, 2B, 4A, and 4B and the backlight unit 1000 may be configured by disposing at least one light source apparatus 100 on the base substrate 10.

As shown in FIG. 5, the base substrate 10 on which the light source part 1 is mounted may be disposed within a cover part 3. The cover part 3 may have a bottom surface and inclined side walls. The light source part 1 is disposed on the bottom surface of the cover part 3 to irradiate light upwardly and a diffusing plate 2 is disposed on a top surface of the cover part 3 to emit the light irradiated from the light source part 1 to the outside.

The diffusing plate 2 may diffuse the light emitted from the light source part 1 to uniformly emit light from a front surface of the diffusing plate 2. The diffusing plate 2 may be made of transparent plastic-based materials having a high refractive index, for example, polycarbonate (PC), polymethylmethacrylate (PMMA), and the like. In addition, materials or beads for diffusing light may be included in the inside of the diffusing plate, and an unevenness portion may be formed on a surface of the diffusing plate in order to increase light extraction efficiency. An optical sheet for diffusing light may be further provided in the top or bottom part of the diffusing plate 2.

The backlight unit 1000 according to an exemplary embodiment includes the automatic aligned type light source part 1 in which the centers of the light source 20 and the lens 30 coincide with each other, thereby providing improved light uniformity. In detail, in the case of a backlight unit including at least one light source part, the optical axes of the light source and the lens of the light source part do not coincide with each other and thus, the light emission characteristics thereof may vary, thereby degrading light uniformity. However, according to an exemplary embodiment, the light source part 1 is automatically aligned such that the central axes of the light source 20 and the lens 30 coincide with each other, and thus, a backlight unit 1000 having light uniformity and precision while using a minimal number of light sources 20 can be provided.

As set forth above, according to an exemplary embodiment, a light source apparatus having improved light emission characteristics may be provided.

According to another exemplary embodiment, a method of manufacturing a light source apparatus providing improved manufacturing efficiency through simplifying the manufacturing process and saving on manufacturing costs.

According to another exemplary embodiment, a backlight unit with improved light uniformity and precision may be provided.

While exemplary embodiments have been shown and described above, it will be apparent to those skilled in the art that modifications and variations can be made without departing from the spirit and scope of the inventive concept as defined by the appended claims.

What is claimed is:

1. A light source apparatus comprising:
a base substrate;
a light source disposed on the base substrate, the light source comprising an outer peripheral surface;
a lens disposed over the light source and comprising a hollow part in which the light source is housed, the hollow part having a shape corresponding to the outer peripheral surface of the light source; and
an adhesive fixing the lens to the base substrate in a state in which the outer peripheral surface of the light source contacts an inner surface of the hollow part of the lens.

2. The light source apparatus of claim 1, wherein a center axis of the light source coincides with a center axis of the lens in the state in which the outer peripheral surface of the light source contacts the at least a part of the inner surface of the hollow part.

3. The light source apparatus of claim 1, wherein the outer peripheral surface of the light source comprises a curved surface and the inner surface of the hollow part of the lens comprises a curved surface.

4. The light source apparatus of claim 1, wherein the hollow part of the lens comprises:
a first area having a shape corresponding to the outer peripheral surface of the light source; and
a second area having a concave semispherical shape in which the light source is housed.

5. The light source apparatus of claim 4, wherein the outer peripheral surface of the light source contacts the first area.

6. The light source apparatus of claim 4, wherein the lens further comprises a protruded part in an inner peripheral surface of the first area.

7. The light source apparatus of claim 6, wherein the outer peripheral surface of the light source contacts the protruded part.

8. The light source apparatus of claim 1, wherein:
the lens further comprises a convex part protruded outwardly away from the light source; and
the convex part has a concave part formed therein.

9. The light source apparatus of claim 1, wherein the lens is fixed to the base substrate without being in contact with the base substrate.

10. The light source apparatus of claim 1, wherein:
the lens includes a convex part protruded upwardly, and the convex part has a concave part formed therein,
a center axis of the convex part coincides with a center axis of the concave part, and
the light source is disposed on the center of the convex part and the concave part.

11. A method of manufacturing a light source apparatus, the method comprising:
disposing a light source on a base substrate, the light source comprising an outer peripheral surface;
applying an adhesive having fluidity to an area surrounding the light source of the base substrate;
disposing a lens on the adhesive having fluidity, the lens comprising a hollow part in which the light source is housed; and
fixing the lens to the base substrate by the adhesive in a state in which the outer peripheral surface of the light source contacts an inner surface of the hollow part.

12. The method of claim 11, wherein, in the disposing of the lens on the adhesive, the lens is automatically aligned so that the outer peripheral surface of the light source contacts the inner surface of the hollow part of the lens.

13. The method of claim 11, wherein a center axis of the light source coincides with a center axis of the lens in the state in which the outer peripheral surface of the light source contacts the inner surface of the hollow part of the lens.

14. The method of claim 11, wherein the hollow part of the lens comprises:
a first area having a shape corresponding to the outer peripheral surface of the light source; and
a second area having a concave semispherical shape in which the light source is housed.

15. The method of claim 14, wherein the outer peripheral surface of the light source is fixed in a state in which the outer peripheral surface of the light source contacts the first area.

16. A backlight unit comprising:
a base substrate; and
a light source part that is disposed on the base substrate, the light source part comprising:
a light source that is disposed on the base substrate, the light source comprising an outer peripheral surface;
a lens that is disposed over and houses the light source, the lens comprising a hollow part having a shape corresponding to the outer peripheral surface of the light source; and
an adhesive that fixes the lens to the base substrate in a state in which the outer peripheral surface of the light source contacts an inner surface of the hollow part of the lens.

17. The backlight unit of claim 16, further comprising:
a cover part which covers the light source part; and
a light diffusing plate which diffuses light emitted by the light source.

18. The backlight unit of claim 16, wherein a center axis of the light source coincides with a center axis of the lens in the state in which the outer peripheral surface of the light source contacts the at least a part of the inner surface of the hollow part.

19. The backlight unit of claim 16, wherein the adhesive comprises a thermosetting material.

20. The backlight unit of claim 16, wherein the hollow part of the lens comprises:
a first area having a shape corresponding to the outer peripheral surface of the light source; and
a second area having a concave semispherical shape in which the light source is housed.
